(19) United States
(12) Patent Application Publication
(10) Pub. No.: US 2024/0377821 A1
(43) Pub. Date: Nov. 14, 2024

(54) Unified Data Platform for Protection, Control, and Automation Device Configurations

(71) Applicant: Quanta Technology, LLC, Raleigh, NC (US)

(72) Inventors: Saman Alaeddini, Toronto (CA); Tim Chang, Toronto (CA)

(21) Appl. No.: 18/660,410

(22) Filed: May 10, 2024

Related U.S. Application Data
(60) Provisional application No. 63/465,266, filed on May 10, 2023.

(51) Int. Cl. G05B 23/02

(52) U.S. Cl. CPC G05B 23/0283; G05B 2223/06

(57) ABSTRACT

A computing system obtains, for each of multiple devices, manufacturer-specific configuration data that is specific to a manufacturer of the device and that configures the device for protection, automation, or control of a power system. The computing system translates, for each of the devices, the manufacturer-specific configuration data for the device into generalized configuration data for the device that is manufacturer-agnostic. The computing system stores the generalized configuration data for each of the devices in a common data storage that is commonly accessible by applications configured to use the generalized configuration data to evaluate protection, automation, or control of the power system.

### RELATED APPLICATIONS

This application claims the benefit of U.S. Provisional Application No. 63/465,266, filed May 10, 2023, the entire contents of which are incorporated herein by reference.

### BACKGROUND

Protection in a power system refers to the measures and equipment put in place to detect and isolate faults or abnormal conditions that could otherwise lead to equipment damage, power outages, or safety hazards. The primary goal of protection is to minimize the impact of faults by swiftly disconnecting affected components or sections from the rest of the system. Devices that protect a power system include for example protective relays, circuit breakers, and fuses.

Automation involves the use of control systems and technologies to operate and manage the power system efficiently and with minimal human intervention. Automation aims to improve system reliability, response time to faults, and overall operational efficiency. Devices that provide automation include for example automatic reclosers or sectionalizers, which can automatically restore power or isolate faults without manual intervention.

Control in the context of a power system refers to the management of power system parameters such as voltage, frequency, and power flow to ensure stable and reliable operation. A control device may for example perform capacitor bank switching for such purpose. Devices that form control systems may adjust these parameters based on real-time measurements and operational requirements.

Protection, control and automation devices are thereby integral aspects of modern power systems, working together to ensure safety, reliability, and efficiency in electricity generation, transmission, and distribution. These devices may for example respond quickly to faults, manage grid operations effectively, and maintain stable and reliable power supply to consumers.

Engineers responsible for these devices will face increasing challenges in meeting protection and control performance, new and emerging regulatory requirements, and supporting the utility's operational and data analytics needs. Digital solutions, especially data-driven evaluations and analytics that provide engineers with new assessment and controls capabilities in the operation of the grid, are at the forefront of meeting these continued and emerging challenges. These digital solutions, however, are implemented in silos for specific applications and with limited consideration for cross-department accessibility or data compatibility. Further, governance and utilization processes are underdeveloped, exemplifying the adage of “Data Rich and Information Poor” (DRIP) and limiting the reliability, flexibility, and effectiveness of digital data-driven processes.

Further in this regard, configuration data for configuring protection, control and automation devices has heretofore been stored in stand-alone applications (databases or folder structures) and in formats that are manufacturer-specific. For example, configuration data for configuring protective relays manufactured by Schweitzer Engineering Laboratories (SEL) has heretofore been stored in relay database files (.RDB) files which are proprietary and specific to SEL. This creates a number of challenges for utilities to effectively use configuration data, especially across different applications. Such challenges for example include: siloed utilization, format and configuration incompatibilities, data integrity concerns, data overload issues, and changing requirements.

### SUMMARY

Some embodiments herein generalize manufacturer-specific configuration data of protection, control, or automation devices and store the generalized configuration data in a way that makes it commonly accessible to multiple applications. The generalization of the configuration data may for instance involve translating the manufacturer-specific configuration data into a form that is manufacturer-agnostic, so that the configuration data can be read and processed by any application that understands the generalized form of the configuration data. Indeed, in some embodiments, the generalized configuration data for a device represents the manufacturer-specific configuration data for the device with manufacturer-agnostic terminology, manufacturer-agnostic expression(s), and/or manufacturer-agnostic parameter(s). Moreover, some embodiments store the generalized configuration data in a common data storage, e.g., divorced from any stand-alone application that would utilize the configuration data, so that the generalized configuration data is accessible by multiple applications rather than being confined to a single application. The generalized configuration data as so stored in the common data storage may for instance be accessible by any number of applications via the same, common interface to the common data storage. According to some embodiments, then, the generalization of manufacturer-specific configuration data into a manufacturer-agnostic form and the storage of the generalized configuration data in a commonly accessible storage improves the accessibility, usability, and cross-application inter-operability of the configuration data.

More particularly, embodiments herein include a method, e.g., performed by a computing system. The method comprises obtaining, for each of multiple devices, manufacturer-specific configuration data that is specific to a manufacturer of the device and that configures the device for protection, automation, or control of a power system. The method also comprises translating, for each of the devices, the manufacturer-specific configuration data for the device into generalized configuration data for the device that is manufacturer-agnostic. The method also comprises storing the generalized configuration data for each of the devices in a common data storage that is commonly accessible by applications configured to use the generalized configuration data to evaluate protection, automation, or control of the power system.

In some embodiments, said translating comprises, for each of the devices, processing the manufacturer-specific configuration data for the device to identify one or more operational functions with which the manufacturer-specific configuration data configures the device. In some embodiments, said translating comprises, for each of the devices, translating manufacturer-specific parameters in the manufacturer-specific configuration data that support the one or more operational functions into generalized parameters that are manufacturer-agnostic. In some embodiments, processing the manufacturer-specific configuration data for a device to identify one or more operational functions with which the manufacturer-specific configuration data configures the device comprises parsing programmable logic in the manufacturer-specific configuration data for the device to determine one or more operational functions that underly the programmable logic. In some embodiments, processing the manufacturer-specific configuration data for a device to identify one or more operational functions with which the manufacturer-specific configuration data configures the device comprises identifying, from the one or more determined operational functions, one or more active operational functions that are active in the programmable logic, by checking which of the one or more determined operational functions are enabled according to one or more respective enable fields in the manufacturer-specific configuration data. In some embodiments, the one or more operational functions include one or more tripping elements.

In some embodiments, the generalized configuration data for a device represents the manufacturer-specific configuration data for the device with manufacturer-agnostic terminology. In other embodiments, the generalized configuration data for a device represents the manufacturer-specific configuration data for the device with alternatively or additionally one or more manufacturer-agnostic expressions. In other embodiments, the generalized configuration data for a device represents the manufacturer-specific configuration data for the device with alternatively or additionally one or more manufacturer-agnostic parameters.

In some embodiments, the common data storage comprises a database of generalized configuration data organized and stored based on logical identification and/or classification of devices.

In some embodiments, the method further comprises executing the applications. In some embodiments executing the applications comprises, for each of the executed applications, retrieving, by the executed application, from the common data storage, generalized configuration data for one or more of the devices. In some embodiments executing the applications comprises, for each of the executed applications, performing, by the executed application, evaluation of the retrieved generalized configuration data and/or evaluation of protection, automation, or control of the power system provided by the one or more devices as configured according to the retrieved generalized configuration data. In some embodiments, executing the applications further comprises, for each of the executed applications, outputting results of the evaluation by the executed application to a separate common data storage that is logically and/or physically separate from the common data storage storing the generalized configuration data and that commonly stores results of the respective evaluations by the executed applications. In some embodiments, the method further comprises retrieving, from the separate common data storage, the results output by one or more of the executed applications. In some embodiments, the method further comprises generating one or more reports about the retrieved results. In some embodiments, the method further comprises storing or outputting the one or more reports.

In some embodiments, the method further comprises, for each of the devices, sanitizing the manufacturer-specific configuration data to remove data designated as sensitive data, and to translate the sanitized manufacturer-specific configuration data.

Other embodiments herein include a computing system. The computing system comprises processing circuitry configured to obtain, for each of multiple devices, manufacturer-specific configuration data that is specific to a manufacturer of the device and that configures the device for protection, automation, or control of a power system. The computing system comprises processing circuitry also configured to translate, for each of the devices, the manufacturer-specific configuration data for the device into generalized configuration data for the device that is manufacturer-agnostic. The computing system comprises processing circuitry also configured to store the generalized configuration data for each of the devices in a common data storage that is commonly accessible by applications configured to use the generalized configuration data to evaluate protection, automation, or control of the power system.

In some embodiments, the processing circuitry is configured to, for each of the devices, process the manufacturer-specific configuration data for the device to identify one or more operational functions with which the manufacturer-specific configuration data configures the device. In some embodiments, the processing circuitry is configured to, for each of the devices, translate manufacturer-specific parameters in the manufacturer-specific configuration data that support the one or more operational functions into generalized parameters that are manufacturer-agnostic. In some embodiments, the processing circuitry is configured to process the manufacturer-specific configuration data for a device to identify one or more operational functions with which the manufacturer-specific configuration data configures the device. In some embodiments, processing the manufacturer-specific configuration data for a device comprises parsing programmable logic in the manufacturer-specific configuration data for the device to determine one or more operational functions that underly the programmable logic. In some embodiments, processing the manufacturer-specific configuration data for a device comprises identifying, from the one or more determined operational functions, one or more active operational functions that are active in the programmable logic, by checking which of the one or more determined operational functions are enabled according to one or more respective enable fields in the manufacturer-specific configuration data. In some embodiments, the one or more operational functions include one or more tripping elements.

In some embodiments, wherein the common data storage comprises a database of generalized configuration data organized and stored based on logical identification and/or classification of devices.

In some embodiments, the processing circuitry is configured to execute the applications by, for each of the executed applications, retrieving, by the executed application, from the common data storage, generalized configuration data for one or more of the devices. In some embodiments, the processing circuitry is configured to execute the applications by, for each of the executed applications, performing, by the executed application, evaluation of the retrieved generalized configuration data and/or evaluation of protection, automation, or control of the power system provided by the one or more devices as configured according to the retrieved generalized configuration data. In some embodiments, the processing circuitry is configured to execute the applications further by, for each of the executed applications, outputting results of the evaluation by the executed application to a separate common data storage that is logically and/or physically separate from the common data storage storing the generalized configuration data and that commonly stores results of the respective evaluations by the executed applications. In some embodiments, the processing circuitry is further configured to retrieve, from the separate common data storage, the results output by one or more of the executed applications. In some embodiments, the processing circuitry is further configured to generate one or more reports about the retrieved results. In some embodiments, the processing circuitry is further configured to store or output the one or more reports.

In some embodiments, the processing circuitry is further configured to, for each of the devices, sanitize the manufacturer-specific configuration data to remove data designated as sensitive data, and to translate the sanitized manufacturer-specific configuration data.

Other embodiments herein include a method for a computing system comprising an interface to a common data storage that is commonly accessible by applications configured to evaluate protection, automation, or control of a power system, and processing circuitry. The method comprises retrieving, by an application executed by the computing system, from the common data storage via the interface, generalized configuration data for one or more devices that are configured by the generalized configuration data for protection, automation, or control of the power system, wherein the generalized configuration data for a device is agnostic as to a manufacturer of the device. The method also comprises performing, by the executed application, evaluation of the retrieved generalized configuration data and/or evaluation of protection, automation, or control of the power system provided by the one or more devices as configured according to the retrieved generalized configuration data.

In some embodiments, the generalized configuration data for a device represents manufacturer-specific configuration data for the device with manufacturer-agnostic terminology. In other embodiments, the generalized configuration data for a device represents manufacturer-specific configuration data for the device with alternatively or additionally one or more manufacturer-agnostic expressions. In other embodiments, the generalized configuration data for a device represents manufacturer-specific configuration data for the device with alternatively or additionally one or more manufacturer-agnostic parameters.

In some embodiments, the common data storage comprises a database of generalized configuration data organized and stored based on logical identification and/or classification of devices.

In some embodiments, the processing circuitry is further configured to output results of the evaluation by the executed application to a separate common data storage that is logically and/or physically separate from the common data storage storing the generalized configuration data and that commonly stores results of the evaluations by multiple applications. In some embodiments, the method further comprises retrieving, from the separate common data storage, the results output by the executed application. In some embodiments, the method further comprises generating one or more reports about the retrieved results. In some embodiments, the method further comprises storing or outputting the one or more reports.

Other embodiments herein include corresponding apparatus, computer programs, and carriers of those computer programs (e.g., in the form of non-transitory computer-readable storage mediums).

Of course, the present disclosure is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a data translator and common data storage according to some embodiments.

FIG. 2A is a block diagram of translation of manufacturer-specific configuration data to generalized configuration data according to some embodiments.

FIG. 2B is a block diagram of translation of manufacturer-specific configuration data to generalized configuration data according to other embodiments.

FIG. 3 is a block diagram of translation of manufacturer-specific configuration data to generalized configuration data according to yet other embodiments.

FIG. 4 is a block diagram of utilization of generalized configuration data by applications and storage of the results according to some embodiments.

FIG. 5 is a block diagram of a Unified Data Platform according to some embodiments.

FIG. 6 is a block diagram of trip logic processing according to some embodiments.

FIG. 7 is a block diagram of translation of different manufacturer-specific sets of configuration data parameters to respective generalized sets of configuration data parameters according to some embodiments.

FIG. 8 is a block diagram of a relay catalog that describes settings fields according to some embodiments.

FIG. 9 is a block diagram of a high-level report of analytics results according to some embodiments.

FIGS. 10A-10C are block diagrams of formal report-style documentation that can be used as proof-of-compliance for meeting regulatory requirements according to some embodiments.

FIG. 11 is a block diagram of an interactive data visualization dashboard according to some embodiments.

FIG. 12 is a logic flow diagram of a method for configuration data translation and storage according to some embodiments.

FIG. 13 is a logic flow diagram of a method for utilizing generalized configuration data according to some embodiments.

FIG. 14 is a block diagram of a computing system according to some embodiments.

### DETAILED DESCRIPTION

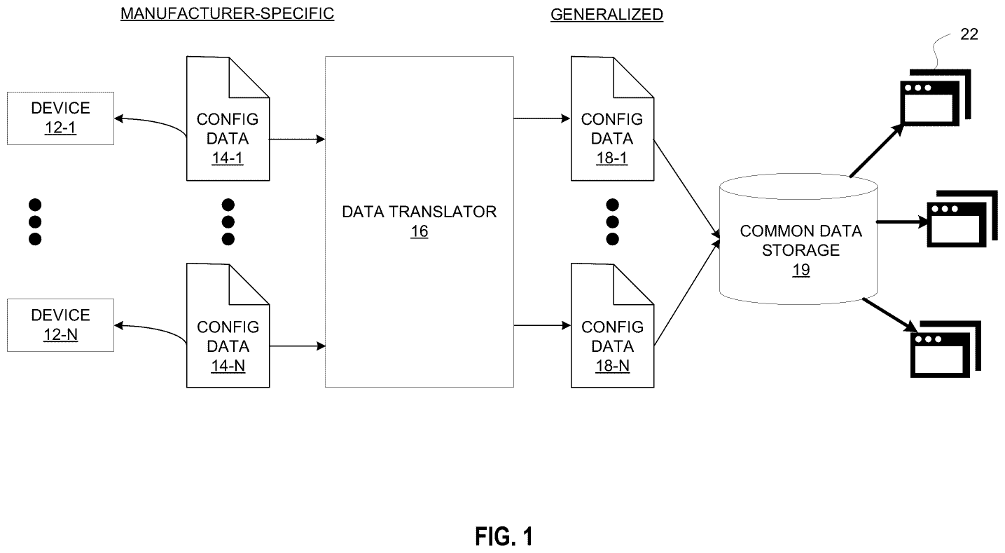

FIG. 1 shows devices 12-1 . . . 12-N for protection, automation, and/or control of a power system, e.g., an electric power transmission and/or distribution system, with N≥2. The devices 12-1 . . . 12-N, generally referred to as devices 12, may for example include protective relays for protecting the power systems, intelligent electronic devices (IEDs) such as programmable controllers, monitoring devices, communications devices, and/or any other configurable or settable device that operates to protect, automate, and/or control the power system. In some embodiments, at least some of the devices 12-1 . . . 12-N are manufactured by different manufacturers.

FIG. 1 more particularly shows configuration data 14-1 . . . 14-N for configuring the respective devices 12-1 . . . 12-N to operate as desired. Configuration data 14-1 . . . 14-N for different devices 12-1 . . . 12-N may be captured in different configuration files or data structures. Although not shown, the configuration data 14-1 . . . 14-N may be stored in a configuration data storage, e.g., a database, file system, or other repository. Examples of such a configuration data storage may include commercially-available protection or asset management repository systems designed to store attributes, configurations, supporting files (configuration or data), statuses, and actions, and to track and facilitate processes associated with the lifecycle of the device. Heretofore, prominent commercially-available software packages include: Doble PowerBase, Advanced System for Process Engineering (ASPEN) Relay Database (RDB), Integrated Planning and Scheduling (IPS) Energy Reliability and Efficiency (RELEX), Det Norske Veritas-Germanischer Lloyd (DNV-GL) Cascade, or International Business Machines (IBM) Maximo. In these and other examples, configuration data 14-1 . . . 14-N may be indexed or searchable according to device identifiers, types, characteristics, or the like.

Regardless, the configuration data 14-1 . . . 14-N as shown is manufacturer-specific. Configuration data 14-1 for device 12-1 is specific to a manufacturer of that device 12-1, configuration data 14-2 for device 12-2 is specific to a manufacturer of that device 12-2, and so on, where manufacturer-specific configuration data for a device 12-n is referred to as manufacturer-specific configuration data 14-n. The manufacturer-specific nature of the configuration data 14-n for a device 14-n means that the configuration data specific to a certain manufacturer cannot natively configure a device from a different manufacturer. In some embodiments, manufacturer-specific configuration data in this regard may include manufacturer-specific terminology, manufacturer-specific expression(s), and/or manufacturer-specific parameter(s) that are specific to a certain manufacturer, i.e., not used in manufacturer-specific configuration data for configuring a device from a different manufacturer.

For example, configuration data in a relay database file (.RDB) file, which is proprietary and specific to Schweitzer Engineering Laboratories (SEL), can natively configure a protective relay device manufactured by SEL, but may not natively configure any device manufactured by General Electric (GE), e.g., because GE devices are configured to understand files that have a different format and that express data and logic differently. As another example, configuration data in a GE Universal Relay Settings (.URS) file, which is proprietary and specific to GE, can natively configure a protective relay manufactured by GE, but may not natively configure any device manufactured by SEL, e.g., because SEL devices are configured to understand files that have a different format and that express data and logic differently. In such examples, then, configuration data 14-1 in FIG. 1 may be included in an SEL .RDB file for configuring a protective relay device manufactured by SEL, while configuration data 14-N may be included in a GE URS file for configuring a protective relay device manufactured by GE. The file format of the .RDB file is proprietary to SEL and expresses data within the file in terminology and forms that are not compatible with other manufacturers. As such, the .RDB file cannot be read, interpreted, or used by the device of any other manufacturer, e.g., no GE device is capable of reading, interpreting, or using an SEL.RDB file because that GE device expects data in a different format with a different logical convention. Conversely, the file format of the .URS file is proprietary to GE and expresses data within the file in terminology and forms that are not compatible with other manufacturers. As such, although multiple types of GE devices can universally read, interpret, and use the .URS file, the .URS file cannot be read, interpreted, or used by the device of any other manufacturer, e.g., no SEL device is capable of reading, interpreting, or using a GE .URS file because that SEL device expects data in a different format with a different logical convention.

The manufacturer-specific nature of the configuration data 14-1 . . . 14-N accordingly means that any given software application would need to be specifically configured to read and process configuration data from multiple different manufacturers in order to support devices from different manufacturers. For example, in order to support protective relay devices manufactured by SEL as well as protective relay devices manufactured by GE, a software application would need to be specifically configured to read and process both .RDB files and .URS files. This introduces undesirable burdens on and obstacles to software application developers, especially as the form of manufacturer-specific configuration data may change from time to time so as to create an ongoing requirement to keep the software application up-to-date.

In this context, embodiments herein notably provide a data translator 16. The data translator 16 obtains, for each of the devices 12-1 . . . 12-N, the manufacturer-specific configuration data 14-n that is specific to a manufacturer of the device 12-n and that configures the device 12-n for protection, automation, or control of the power system. In some embodiments, for example, the data translator 16 obtains at least some of the manufacturer-specific configuration data 14-n by retrieving it from the configuration data storage described above.

In any event, the data translator 16 notably translates the manufacturer-specific configuration data 14-1 . . . 14-N for the respective devices 12-1 . . . 12-N into generalized configuration data 18-1 . . . 18-N for the devices 12-1 . . . 12-N. Generalized configuration data for a device 12-n will be referred to as generalized configuration data 18-n. In other words, the data translator translates, for each of the devices 12-1 . . . 12-N, the manufacturer-specific configuration data 14-n for the device 12-n into generalized configuration data 18-n for the device 12-n. Generalized configuration data 18-n for a device 12-n is generalized in the sense that it is not specific to any one device manufacturer; that is, it is manufacturer-agnostic. For example, the generalized configuration data 18-n for a device 12-n may represent the manufacturer-specific configuration data 14-n for the device 12-n with manufacturer-agnostic terminology, manufacturer-agnostic expression(s), and/or manufacturer-agnostic parameter(s). In this case, then, the data translator 16 may translate manufacturer-specific terminology, manufacturer-specific expression(s), and/or manufacturer-specific parameter(s) in the manufacturer-specific configuration data 14-n for the device 12-n into manufacturer-agnostic terminology, manufacturer-agnostic expression(s), and/or manufacturer-agnostic parameter(s) for inclusion in the generalized configuration data 18-n for the device 12-n

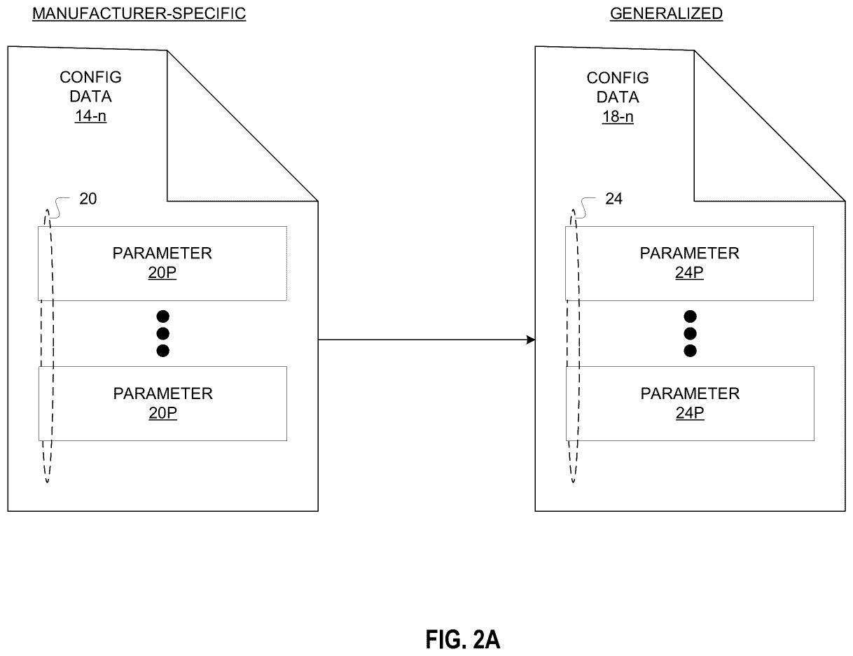

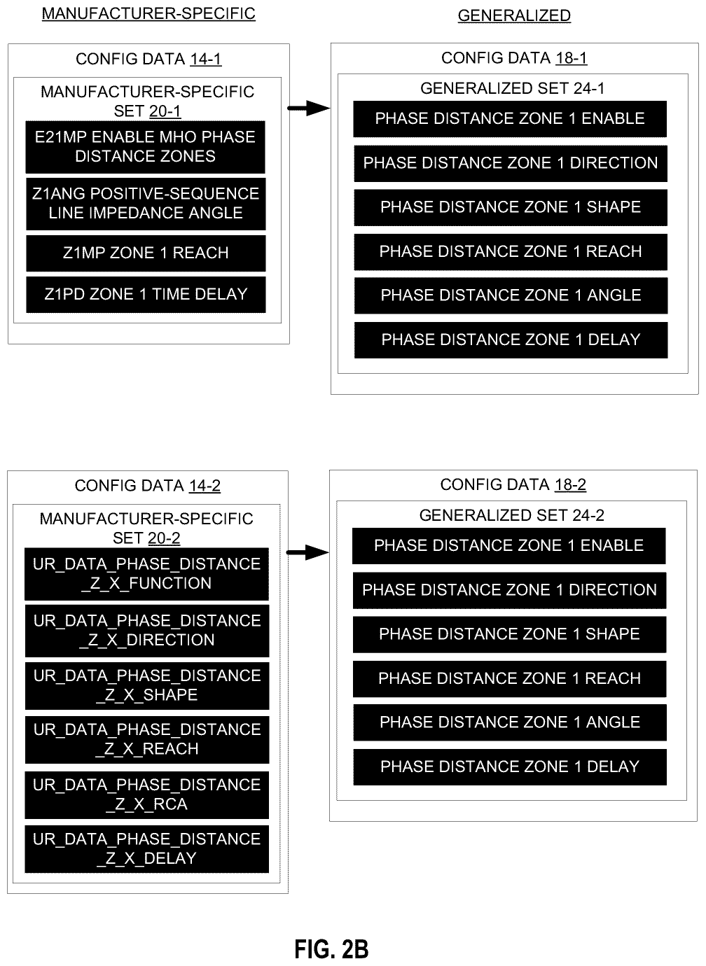

FIG. 2A illustrates this with respect to configuration data parameter(s). As shown, the manufacturer-specific configuration data 14-n for a device 12-n includes a manufacturer-specific set 20 of parameter(s) 20P, where one or more of the parameters 20P in the set 20 are manufacturer-specific. The data translator 16 translates this manufacturer-specific set 20 of parameters 20P into a generalized set 24 of parameter(S) 24P in order to form generalized configuration data 18-n for the device 12-n. One or more of the parameters 20P in the generalized set 24 are generalized so as to be manufacturer-agnostic. With this generalized set 24 of parameter(s) 24P being manufacturer-agnostic, this same generalized set 24 of parameters is able to commonly represent different manufacturer-specific sets of parameters across multiple different manufacturers. FIG. 2B shows an example.

In the example of FIG. 2B, configuration data 14-1 is shown for a device 12-1 from manufacturer 1, e.g., SEL. The device 12-1 may be a certain type of device (e.g., a protective relay device) and/or be configurable to perform a certain operational function (e.g., a tripping function). The configuration data 14-1 for this device 12-1 as such includes a manufacturer-specific set 20-1 of parameters, e.g., that are characteristic of the certain type of the device 12-1 and/or characteristic of its certain operational function. In this example, the parameters in this manufacturer-specific set 20-1 include an E21MP Enable MHO Phase Distance Zones parameter, a Z1ANG Positive-Sequence Line Impedance Angle parameter, a Z1MP Zone 1 Reach parameter, and a Z1PD Zone 1 Time Delay parameter. In one such embodiment, for instance, the device 12-1 is a protective relay device manufactured by SEL. FIG. 2B shows that the data translator 16 translates this manufacturer-specific set 20-1 into a generalized set 24-1 of parameters that is generically applicable to any device of the certain type (e.g., applicable to any protective relay device) and/or to any device configurable to perform the certain operational function (e.g., a tripping function). In this example, the parameters in the generalized set 24-1 include a Phase Distance Zone 1 Enable parameter, a Phase Distance Zone 1 Direction parameter, a Phase Distance Zone 1 Shape parameter, a Phase Distance Zone 1 Reach parameter, a Phase Distance Zone 1 Angle parameter, and a Phase Distance Zone 1 Delay parameter. These parameters in the generalized set 24-1 thereby represent the parameters in the manufacturer-specific set 20-1 in a generic way that is able to describe any device of the certain type and/or any device configurable to perform the certain operational function, without regard to its manufacturer, e.g., without using manufacturer-specific terminology or parameter meanings.

To this point, FIG. 2B also shows configuration data 14-2 for a device 12-2 that is of the same type as device 12-1 (e.g., a protective relay device) and/or that is configurable to perform the same operational function (e.g., a tripping function). However, the device 12-2 is from manufacturer 2 (e.g., GE) rather than manufacturer 1 (e.g., SEL). This configuration data 14-2 for device 12-2 includes a different manufacturer-specific set 20-2 of parameters. The parameters in this manufacturer-specific set 20-2 include a UR_DATA_PHASE_DISTANCE_Z_X_FUNCTION parameter, a UR_DATA_PHASE_DISTANCE_Z_X_DIRECTION parameter, a UR_DATA_PHASE_DISTANCE_Z_X_SHAPE parameter, a UR_DATA_PHASE_REACH_Z_X_REACH parameter, a UR_DATA_PHASE_DISTANCE_Z_X_RCA parameter, and a UR_DATA_PHASE_DISTANCE_Z_X_DELAY parameter. FIG. 2B shows that the data translator translates this manufacturer-specific set 20-2 into a generalized set 24-2 of parameters that is generically applicable to any device of the certain type (e.g., applicable to any protective relay device) and/or to any device configurable to perform the certain operational function (e.g., a tripping function). The same as the generalized set 24-1 in generalized configuration data 24-1 for device 12-1, the parameters in the generalized set 24-2 include a Phase Distance Zone 1 Enable parameter, a Phase Distance Zone 1 Direction parameter, a Phase Distance Zone 1 Shape parameter, a Phase Distance Zone 1 Reach parameter, a Phase Distance Zone 1 Angle parameter, and a Phase Distance Zone 1 Delay parameter. These parameters in the generalized set 24-2 thereby similarly represent the parameters in the manufacturer-specific set 20-2 in a generic way that is able to describe any device of the certain type and/or any device configurable to perform the certain operational function, without regard to its manufacturer.

As demonstrated by FIG. 2B, then, the data translator 16 according to some embodiments may translate manufacturer-specific configuration data 14-1 . . . 14-N for at least some devices 12-1 . . . 12-N that are of the same type (e.g., protective relay device) and/or that perform the same operational function (e.g., a tripping function), but are manufactured by different manufacturers. The data translator 16 may translate such manufacturer-specific configuration data 14-1 . . . 14-N into generalized configuration data 16-1 . . . 16-N that is generically applicable to any device of that type and/or to any device configurable to perform that operational function, regardless of its manufacturer.

The generalized nature of the generalized configuration data 18-n accordingly relieves any given software application from having to be specifically configured to read and process configuration data from multiple different manufacturers in order to support devices from different manufacturers. For example, rather than having to support protective relay devices manufactured by SEL as well as protective relay devices manufactured by GE, a software application need simply be able to read and process generalized configuration data 18-n. Some embodiments accordingly reduce the burdens on and obstacles to software application developers.

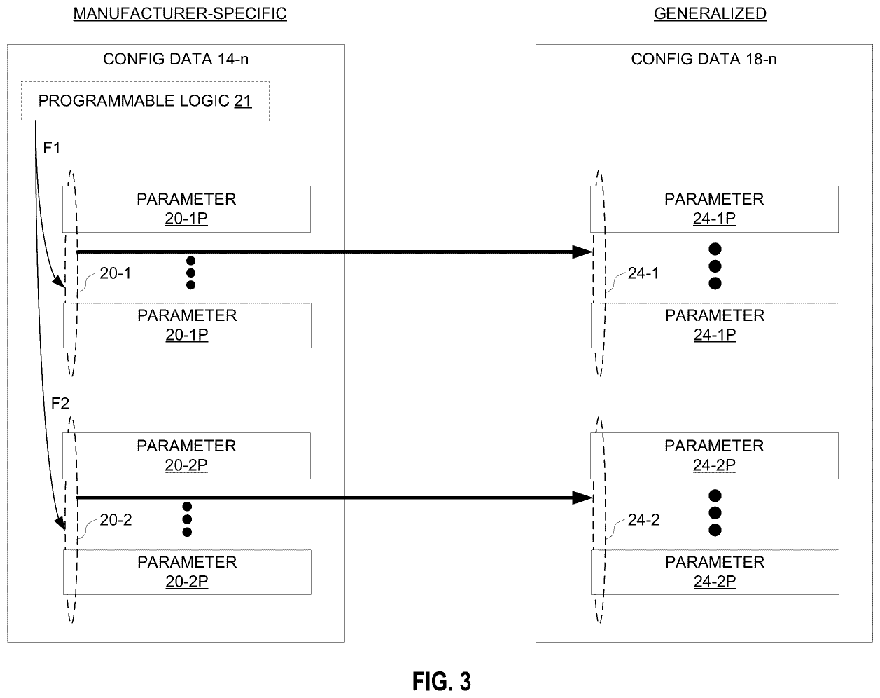

Note that, in order to translate manufacturer-specific configuration data 14-1 . . . 14-N into generalized configuration data 16-1 . . . 16-N that is generically applicable to any device configurable to perform a certain operational function, the data translator 16 in some embodiments processes the manufacturer-specific configuration data 14-n for a device 12-n in order to identify one or more operational functions with which the manufacturer-specific configuration data 14-n configures the device 12-n. FIG. 3 for example shows that manufacturer-specific configuration data 14-n may include programmable logic 21 (e.g., SELogic control equations) via which the device 12-n may be programmable to perform any of a number of operational functions (e.g., tripping). The data translator 16 in this case may parse the programmable logic 21 to determine one or more operational functions that underly the programmable logic 21. In the example of FIG. 3, for instance, the data translator 16 determines that operational functions F1 and F2 underly the programmable logic 21. The data translator 16 accordingly translates manufacturer-specific parameters 20P in the manufacturer-specific configuration data 14-n that support the operational functions F1 and F2 into generalized parameters 24P that are manufacturer-agnostic. In the example of FIG. 3, for instance, the data translator 16 determines that the manufacturer-specific set 20-1 of parameter(s) 20-1P supports operational function F1 and the manufacturer-specific set 20-2 of parameter(s) 20-12 supports operational function F2. The data translator thereby translates the manufacturer-specific set 20-1 of parameter(s) 20-1P that supports operational function F1 into the generalized set 24-1 of parameter(s) 24-1P, and translates the manufacturer-specific set 20-2 of parameter(s) 20-2P that supports operational function F2 into the generalized set 24-2 of parameter(s) 24-2P.

Note, though, that in some embodiments the data translator 16 limits the operational function(s) for which it performs translation to those that are actually active. That is, even if the programmable logic 21 implicates an operational function, that operational function may actually be activated or inactivated by one or more enable fields in the manufacturer-specific configuration data 14-n. Accordingly, in some embodiments, the data translator 16 identifies, from the determined operational function(s), active operational function(s) that are active in the programmable logic 21. The data translator 16 may do so by checking which of the determined operational function(s) are enabled according to one or more respective enable fields in the manufacturer-specific configuration data 14-n.

Note, too, that in some embodiments the manufacturer-specific configuration data 14-n for a device 12-n may be encrypted, or at least the file in which the manufacturer-specific configuration data 14-n is contained is encrypted. In this case, the manufacturer-specific configuration data 14-n or the containing file may be decrypted before translation. For example, where the manufacturer-specific configuration data 14-n is contained in a GE URS file, the GE URS file may be decrypted in order to retrieve the manufacturer-specific configuration data 14-n contained within the file.

Furthermore, some embodiments herein account for the sensitive nature of some manufacturer-specific configuration data 14-n. Sensitive data may for example include Critical Energy Infrastructure Information (CEII) comprising information related to critical energy infrastructure, such as power plants, pipelines, and other facilities that could pose a security risk if disclosed to unauthorized individuals or entities. This sensitive information may be regulated by government agencies and may be subject to strict confidentiality requirements to protect national security and ensure the reliability and resilience of the energy infrastructure. In one embodiment, then, before translation, some embodiments sanitize the manufacturer-specific configuration data 14-n to remove data designated as sensitive data. In this case, the data translator 16 translates the sanitized manufacturer-specific configuration data.

In any event, returning back to FIG. 1, the data translator 16 in some embodiments stores the generalized configuration data 18-1 . . . 18-N for each of the devices 12-1 . . . 12-N in a common data storage 19. This common data storage 19 is common in the sense that it is commonly accessible by multiple applications 22 that are configured to use the generalized configuration data 18-1 . . . 18-N, e.g., to evaluate the generalized configuration data 18-1 . . . 18-N and/or to evaluate protection, automation, or control of the power system according to the generalized configuration data 18-1 . . . 18-N. Driven by such configuration data 18-1 . . . 18-N, the applications 22 may appropriately be referred to as data-driven applications 22. The common data storage 19 may be divorced from any single application, so that the generalized configuration data 18-1 . . . 18-N is accessible by multiple applications 22 rather than being confined to a single application. The common data storage 19 may for example be a database, file system, or other repository that is not specific to or integrated into any given one of the applications 22. Rather, the common data storage 19 may be considered as centralized storage that centralizes the generalized configuration data 18-1 . . . 18-N in one storage location for facilitating access to the generalized configuration data 18-1 . . . 18-N across multiple applications 22. The generalized configuration data 18-1 . . . 18-N as so stored in the common data storage 19 may for instance be accessible by any number of applications 22 via the same, common interface to the common data storage 19. In one such embodiment, the common data storage 19 comprises a database or repository of the generalized configuration data 18-1 . . . 18-N organized and stored based on logical identification and/or classification of devices 12-1 . . . 12-N. The common data storage 19 may thereby operates as both a destination repository for the generalized configuration data 18-1 . . . 18-N after translation, and a source repository for applications 22 to retrieve the generalized configuration data 18-1 . . . 18-N for use. By facilitating such cross-application access to generalized configuration data 18-1 . . . 18-N some embodiments prevent each application 22 from having to perform its own translation of the manufacturer-specific configuration data 14-1 . . . 14-N. According to some embodiments, then, the generalization of manufacturer-specific configuration data 14-1 . . . 14-N into a manufacturer-agnostic form and the storage of the generalized configuration data 18-1 . . . 18-N in a commonly accessible storage 19 improves the accessibility, usability, and cross-application inter-operability of the configuration data.

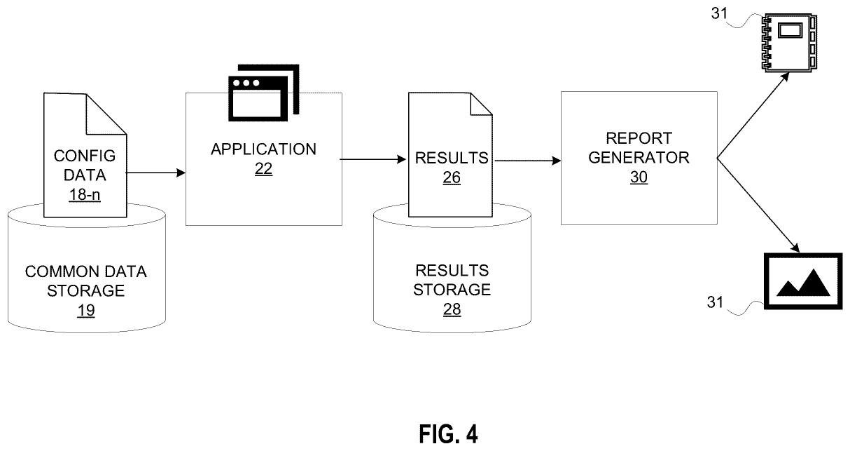

FIG. 4 illustrates other embodiments herein that also exploit a common data storage for storing the results of evaluation by the applications 22, rather than isolating those results to each respective application 22. As shown, an application 22 retrieves the generalized configuration data 18-n for a device 12-n from the common data storage 19. In some embodiments, the application 22 performs evaluation of the retrieved generalized configuration data 18-n. Such may for instance involve validating whether or not the retrieved generalized configuration data 18-n conforms to one or more requirements, e.g., expected functions for given applications, expected configuration setpoints for given applications, adherence to conventions such as naming or organizational conventions, or data availability for all parameters. Alternatively or additionally, the application 22 performs evaluation of protection, automation, or control of the power system provided by the device 12-n as configured according to the retrieved generalized configuration data 18-n. Such may involve assessing how well the device 12-n, when configured according to the retrieved generalized configuration data 18-n, performs in protecting, automating, or controlling the power system, assessing compliance with one or more regulations governing protection, automation, or control of the power system, performing analysis of the generalized configuration data 18-n according to engineering and mathematical processes to derive insights and conclusions that can facilitate decision making in planning, operating, or maintaining the power system, or the like. No matter the particular type of evaluation, though, the application 22 as shown notably outputs results 26 of the evaluation to a separate common data storage, shown as results storage 28. This results storage 28 may be logically and/or physically separate from the common data storage 19 for storing the generalized configuration data 18-n. Moreover, in some embodiments, other ones of the applications 22 may similarly store results of their evaluations in the same results storage 28 such that the results storage 28 commonly stores results 26 of the respective evaluations by the applications 22.

The common storage of results 26 in the results storage 28 advantageously facilitates reporting of the results 26 even as across different applications 22. FIG. 4 in this regard shows that a report generator 30 may retrieve, from the results storage 28, the results 28 output by one or more of the applications 22. The report generator 30 may then generate one or more reports 31 about the retrieved results 26. The report(s) 31 may for instance include spreadsheet(s), formal report-style presentation(s), data dashboard(s), or the like. The report generator 30 may then store or output the report(s), e.g., for presenting the report(s) 31 of the results 28 to interested parties.

In some embodiments, any one or more of the data translator 16, the common data storage 19, the application(s) 22, the results storage 28, and the report generator 30 may be implemented as a so-called Unified Data Platform. The Unified Data Platform, as the name implies, is a platform that unifies device configuration data to be manufacturer-agnostic and/or for use by multiple applications 22.

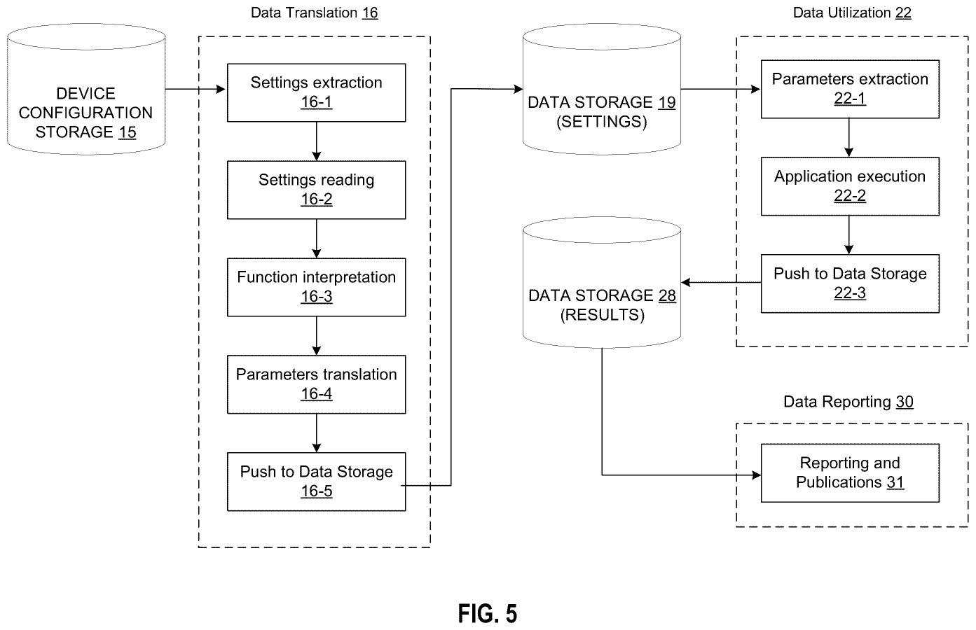

FIG. 5 shows one specific embodiment of such a Unified Data Platform. In this embodiment, the Unified Data Platform facilitates data-driven applications for protection, control, and automation device configurations through three main processes or components: data translation, data utilization, and data reporting. Data Translation, Data Utilization, and Data Reporting in FIG. 5 are referred to in FIG. 5 with reference numbers from FIGS. 1 and 4 corresponding respectively to the data translator 16 that performs Data Translation, the applications 22 that perform Data Utilization, and the report generator 30 that performs Data Reporting.

Data Translation 16 in the embodiment of FIG. 5 includes translation of configuration data 14-1 . . . 14-N to a generalized form and storage of the translated configuration data 18-1 . . . 18-N within a medium for use in data-driven applications. Data Utilization 22 in FIG. 5 involves use of the translated configuration data 18-1 . . . 18-N for simulation studies, data analytics, and compliance evaluations, and storage of results within an accessible medium for reporting and publication. Data Reporting 30 in FIG. 5 involves reporting and/or publication of results as per the application to support utility needs. Together, these three processes enable configuration data to be utilized across applications in a consistent manner and with minimal manual intervention.

More particularly, in this embodiment, manufacturer-specific configuration data 14-1 . . . 14-N is stored in device configuration storage 15. Examples of device configuration storage include any commercially-available protection or asset management repository systems designed to store attributes, configurations, supporting files (configuration or data), statuses, and actions, and to track and facilitate processes associated with lifecycle of the device.

The Data Translation 16 component of the platform in the embodiment of FIG. 5 represents the preparation stage as device configuration data 14-1 . . . 14-N is transformed and made available for utilization in data-driven applications 22. In some embodiments, this entire component is implemented as a single integrated process that requires minimal manual intervention, starting with the data 14-1 . . . 14-N within the storage medium 15 for device configurations and ending with the translated configuration data 18-1 . . . 18-N within the storage medium 19 for generalized settings. In the embodiment of FIG. 5, the Data Translation 16 process consists of five stages.

The first stage of Data Translation 16 is settings extraction 16-1. Settings extraction 16-1 comprises extraction of settings file(s) or parameters from the device configuration storage 15, where such setting file(s) or parameters represents or exemplifies manufacturer-specific configuration data 14-1 . . . 14-N. If the settings file(s) or parameters have been revised over time, the device configuration storage 15 may store multiple different revisions or versions of the settings file(s) or parameters. In this case, settings extraction 16-1 may involve selection of the desired revision according to the envisioned use cases. For example, compliance evaluation applications may need configurations in a “currently deployed” revision to represent the system as-is; other applications such as protection performance studies may need configurations in a “to be deployed” revision to represent the system in an anticipated state.

The second stage of Data Translation 16 is settings reading 16-2. Settings reading 16-2 comprises reading of any settings file, e.g., which may be in a vendor proprietary format.

The third stage of Data Translation 16 is function interpretation 16-3. Function interpretation 16-3 involves identification and interpretation of applicable functions within a device 12, e.g., consisting of those that perform actionable operations.

The fourth stage of Data Translation 16 is parameters translation 16-4. Parameters translation 16-4 comprises translation of parameters supporting the required functions from manufacturer-specific terminology and expression to a universal form.

The fifth stage of Data Translation 16 is a push to data storage 16-5. This involves a push of the translated parameters to the settings data storage 19, e.g., for use in data-driven applications 22.

Like all automation-based processes, Data Translation 16 in FIG. 5 may be reliant on having complete and consistent data in expected formats. Further data integrity routines targeting the settings within the device configuration storage 15 may be considered to ensure the data will reliably and effectively support these processes.

Consider now the stages of Data Translation 16 in more detail.

Regarding settings extraction 16-1, this process obtains the settings files or settings parameters representing the manufacturer-specific configuration data 14-1 . . . 14-N from the device configuration storage 15. This involves connecting to the device configuration storage 15 and identifying the desired settings file(s), e.g., according to pre-defined logic.

In some embodiments, the device configuration storage 15 corresponds to a dedicated database application or file folder hierarchy. Folder structures are relatively simple to navigate, as the structure itself provides organization and a naming convention typically identifies revisions. Connecting to a database may be more involved, but the database in some embodiments is an industry-standard repository databases that is accessible through an Application Programming Interface (API) or Open Database Connectivity (ODBC) connections.

Once the configuration data 14-1 . . . 14-N within the device configuration storage 15 is accessible, identification of the desired settings file or table may occur in two sub-stages. A first sub-stage is identification of the desired device 12-n for which configuration data 14-n will be extracted. This may require understanding of the locational and classification identifiers which describe the device 12-n. A second sub-stage is identification of the desired revision of settings for the device 12-n. This may be application dependent or may be the latest field-deployed version of the settings. Device and settings status parameters may be considerations for this selection, with date or revision identifiers playing a “tie-breaker” role. In some embodiments, the logic behind this hierarchy is pre-defined and pre-programmed.

Once the desired settings file has been identified, the settings file itself (e.g., in manufacturer-proprietary format) is extracted from the device configuration storage 15. For cases where no manufacturer-format settings file is available, internal repository tables may be extracted instead.

Considering settings reading 16-2, once the settings files describing the device configurations have been obtained, the data within may be extracted. Such data accessibility may be dependent on the implementation of a proprietary manufacturer format. Most formats, such as those used for popular protection relay devices in North America (SEL RDB and GE URS files), are not encrypted and can be read as plain text or through processing techniques. However, these files may be organized in forms that cannot easily be read by a human engineer, and thus some embodiments provide processes to pinpoint specific strings or terminology to properly identify parameters in the files.

For those formats that are less conducive to external reading, a representative form of the settings may be utilized. In some embodiments, software reads proprietary settings files and exports these settings in more accessible formats, such as TXT or XML. Although more cumbersome, introducing practices to always create a representative file along with the proprietary one enables this process to be carried out.

Regarding function interpretation 16-3, modern microprocessor-based protection, control, and automation devices provide engineers with a wide range of flexibility in programming settings and configuring functions. The function interpretation 16-3 process of the Unified Data Platform enables automatic identification of operational functions, e.g., according to pre-defined logic. Such operational functions exemplify the operational functions F1 and F2 referred to in FIG. 3. Although some tailoring may be required to support each utility's particular implementation, functions may be set in reasonably consistent manners within an organization.

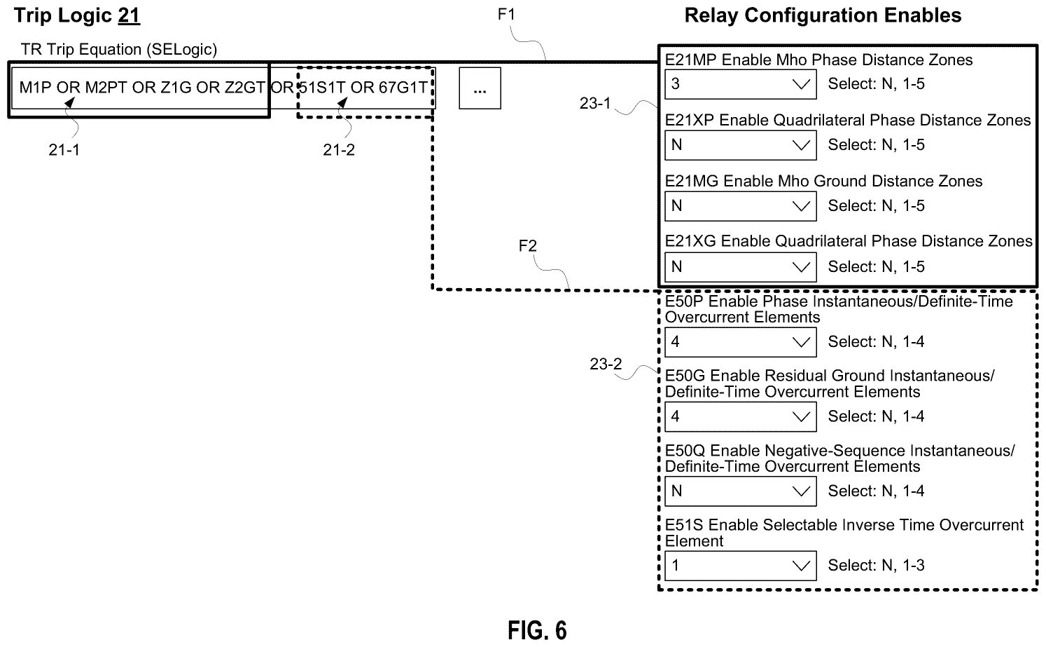

As an example, some of the most widely-deployed protection relays in North America are those from the manufacturer SEL. At a basic level, identification of tripping elements can be made through a combination of the following determinations from configuration data in SEL .RBS files: (1) parsing of relay bit words from the “TR” field, which represents a general trip parameter; and (2) review of “enable” fields for each individual function to confirm those within the “TR” field are actually active. FIG. 6 shows this process for specific example values.

As shown in FIG. 6, an SEL .RBS file includes in the TR field trip logic 21 as a specific example of the programmable logic 21 in FIG. 4. The trip logic 21 may for instance take the form of SELogic control equations. The trip logic 21 determines which protection elements cause the protective relay device to trip unconditionally. The function interpretation 16-3 process involves parsing this trip logic 21 to determine operational function(s) that underly the trip logic 21. In this example, the process determines that a first operational function F1 underlies a first portion 21-1 of the trip logic 21 and that a second operational function F2 underlies a second portion 21-2 of the trip logic 21.

The first portion 21-1 of the trip logic 21 more specifically programs a trip output signal if M1P (Zone 1 Phase Distance, Instantaneous) or M2PT (Zone 2 Phase Distance, Time Delayed) or Z1G (Zone 1 Mho and/or Quad. Distance, Instantaneous) or Z2GT (Zone 2 Ground Distance, Time Delayed) elements are initiated. The second portion 21-2 of the trip logic 21 programs a trip output signal if 51S1T (inverse-time overcurrent element) or 67G1T (Level 1 residual ground definite-time overcurrent element) elements are initiated. As such, the function interpretation 16-3 process parses the trip logic 21 to determine that a first operational function F1 for distance protection underlies the first portion 21-1 of the trip logic 21, and that a second operational function F2 for overcurrent/backup protection underlies the second portion 21-2 of the trip logic 21.

Next, the function interpretation 16-3 reviews the “enable” fields for each individual function F1 and F2 to confirm those within the “TR” field are actually active. As shown, a first set 23-1 of enable fields is reviewed to check whether operational function F1 is active. The E21MP Enable Mho Phase Distance Zones field being set to 3 in this example confirms that the operational function F1 is indeed active. A second set 23-2 of enable fields is also reviewed to check whether operational function F2 is active. The E50G field and the E51S field being set to values other than N in this example confirms that the operational function F2 is active as well.

Further checks may be pursued (such as the “OUT” fields) but the above is generally sufficient for most utilities. Dependent functions, such as directional supervisors, may also be reviewed to determine intended function performance.

Regarding parameters translation 16-4, this process translates the parameters that support each operational function (e.g., F1 and F2) from manufacturer-specific terminology and expression to a generalized form. The conversion to universal terminology enables further applications to focus on general protection and control terms rather than needing to support multiple different manufacturer-specific settings forms.

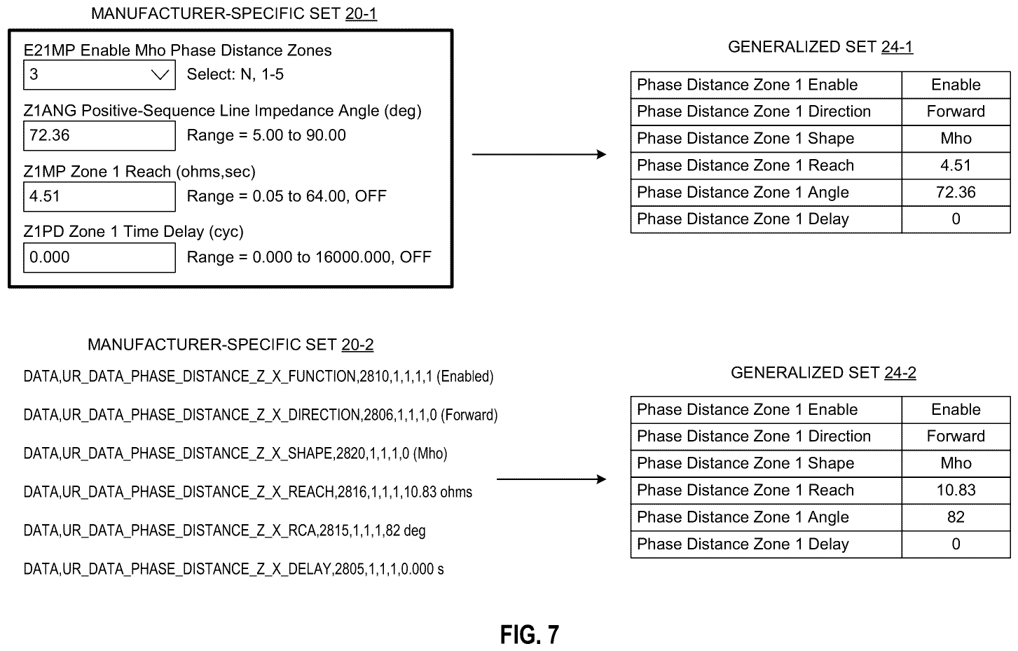

In fact, this parameter translation 16-4 process exemplifies the parameter translation shown in FIGS. 2A, 2B, and 3. FIG. 7 is actually a specific example of the embodiments shown in FIG. 2B, with real-world values indicated for the values of the parameters in the manufacturer-specific sets 20-1, 20-2 and the generalized sets 24-1, 24-2.

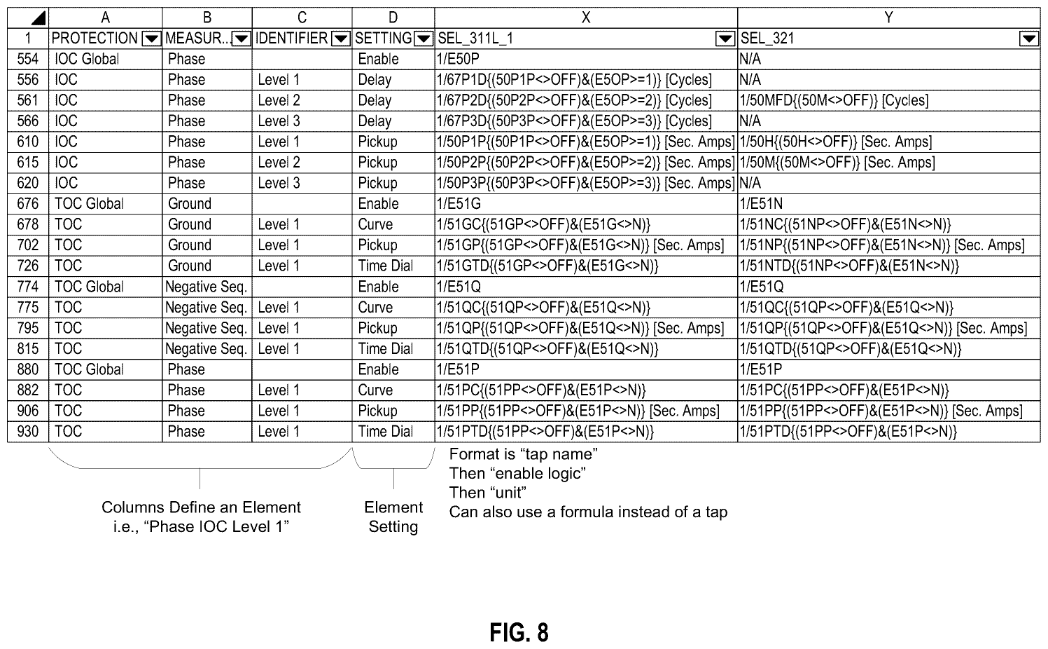

In some embodiments, the Unified Data Platform achieves this parameter translation 16-4 and interpretation through a built-in relay catalog that describes each settings field. FIG. 8 shows one example of such a relay catalog.

Regarding the push to data storage 16-5 process, the resulting translated parameters are pushed to a designated data storage 19 (e.g., a database). The use of intermediate storage (and separation of translation and application processes) improves accessibility of the data and increases flexibility for the data-driven applications 22 that utilize these parameters. In addition to the settings, the schema of this output database may consider organizational characteristics that enable logical identification and classification of the devices 12. The data storage 19 may support external accessibility by different applications 22 (and the unified data platform).

Consider now more details about Data Utilization 22. The Data Utilization component of the platform covers the applications 22 that will use the generalized configuration data 18-1 . . . 18-N. The preparation efforts of the previous stages have simplified the requirements of these applications 22. Indeed, translation to generalized parameters removes requirements for applications 22 to support different manufacturer-specific settings and logic chains. Moreover, use of data storage 19 provides a central location from which to access the generalized configuration data 18-1 . . . 18-N.

In some embodiments, use of data storage 19 enables external applications 22 to access the generalized configuration data 18-1 . . . 18-N outside the Unified Data Platform. However, integration of the data storage 19 within the Unified Data Platform provides a number of advantages. First, execution within the platform may enable the entire process (from device data extraction all the way to reporting) to be carried out with a single user interaction, instead of requiring the user to switch between interfaces or files. Second, the results 22 of the application 22 (performance studies, compliance evaluation, data analytics, etc.) can in turn be pushed to data storage 28. Similar to making configuration settings accessible for external data-driven applications, this second layer of storage 28 makes processed results 26 accessible to a wide range of reporting mediums (documents, publications, further applications, etc.).

The applications 22 themselves represent the primary motivation for improving data accessibility through the data translation process. These applications 22 that will utilize the device configuration data cover a wide range of possibilities. The applications 22 may for instance include one or more applications for modeling of device configurations in simulation software to perform operational performance studies (such as protection coordination). Alternatively or additionally, the applications 22 may include one or more applications for evaluation of compliance requirements that involve protection and control setting characteristic (such as NERC PRC-023 loadability or CIP-010 configuration change management). Alternatively or additionally, the applications 22 may include one or more applications for advanced data analytics that make judgements based on protection and control device statuses, measurements, or settings. These data analytics may include utilization of data from other sources or even departments and represent the gamut of possibilities enabled by modern and emerging monitoring and control systems. Wildfire prevention processes, adaptive protection schemes, and equipment safety thresholds are examples of analytics that can be achieved using this data. Alternatively or additionally, the applications 22 may include one or more applications for reporting considerations for other departments, which may include fault duty values, minimum trip thresholds, and operational protection elements for various equipment. The applications 22 may alternatively or additionally include one or more applications for evaluating device configuration data, such as to review settings files for defined issues or warnings. For example, the most basic checks could include whether required fields are filled in and consistent. More advanced considerations could check whether settings meet protection philosophy guidelines or whether logic is internally consistent (element in trip expression is actually enabled).

Generally, then, one or more of the applications 22 may be described as data-driven application(s). A data-driven application in this sense leverages data to determine its behavior, making it adaptable, responsive to changes, and capable of processing and presenting information in dynamic ways based on the data it receives or manages. An application 22 that is described as “data-driven” means that its design and functionality are heavily influenced by data. This term refers to a software development approach where the application's behavior and features are determined by the data it processes or manages. In a data-driven application, the application relies on various forms of data as its primary input, and the behavior, logic, and flow of the application are determined by the data it receives or processes. Different data inputs can lead to different outcomes or actions within the application.

In some embodiments, the Unified Data Platform includes multiple modules that can access a common set of data libraries that define protection logic or functions, such as the Relay Catalog that enables interpretation of device configurations and generalization of vendor-specific elements. The platform enables seamless sharing of data and integration of processes across modules and applications.

Regardless, the output results 26 of these analytics could be sent directly to reporting mechanisms in traditional implementations of these processes. However, the Unified Data Platform instead supports pushing these results 26 to a second instance of data storage 28, mirroring the data storage 19 for the generalized configuration data with one dedicated for application outputs. Similar to improving accessibility of configuration data 18-1 . . . 18-N, this data storage 28 for results 26 enables the study outputs to be accessed by other external processes, which may include report generators or further applications.

Now concerning the Data Reporting 30, this third component of the platform covers considerations for presenting the output results 26 to interested parties. The data storage 28 for these results 26 enables these outputs to be accessed by processes external to the platform. The platform itself supports one or more forms of output.

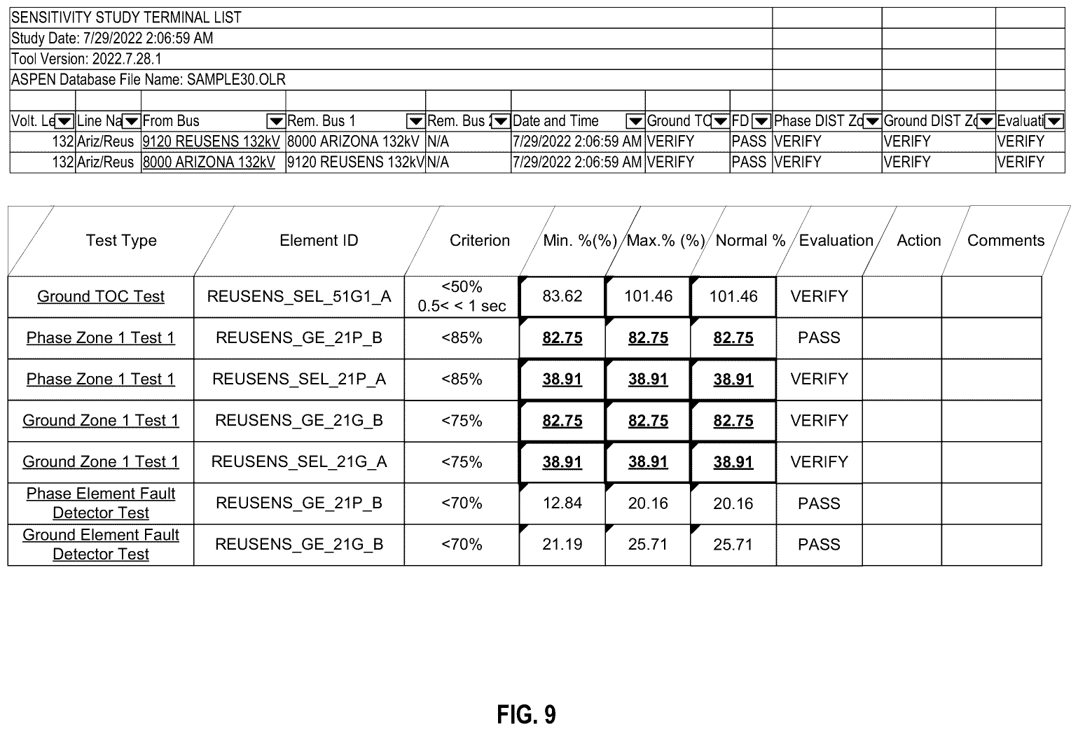

One form of output may be traditional spreadsheets that can provide different levels of detailed views for the analytics results. At their most basic, these levels of detail as shown in FIG. 9 may include a high-level “bird's eye” view of equipment under study, providing engineers with an overall view of the state of their study scope and enabling them to quickly determine where potential issues may lie. A lower-level view shows more details on the evaluation metrics and settings of each function under consideration, enabling engineers to pinpoint what settings or fields may be causing issues. These different levels of detail work in tandem to provide a holistic view of the study scope and help engineers interpret the results.

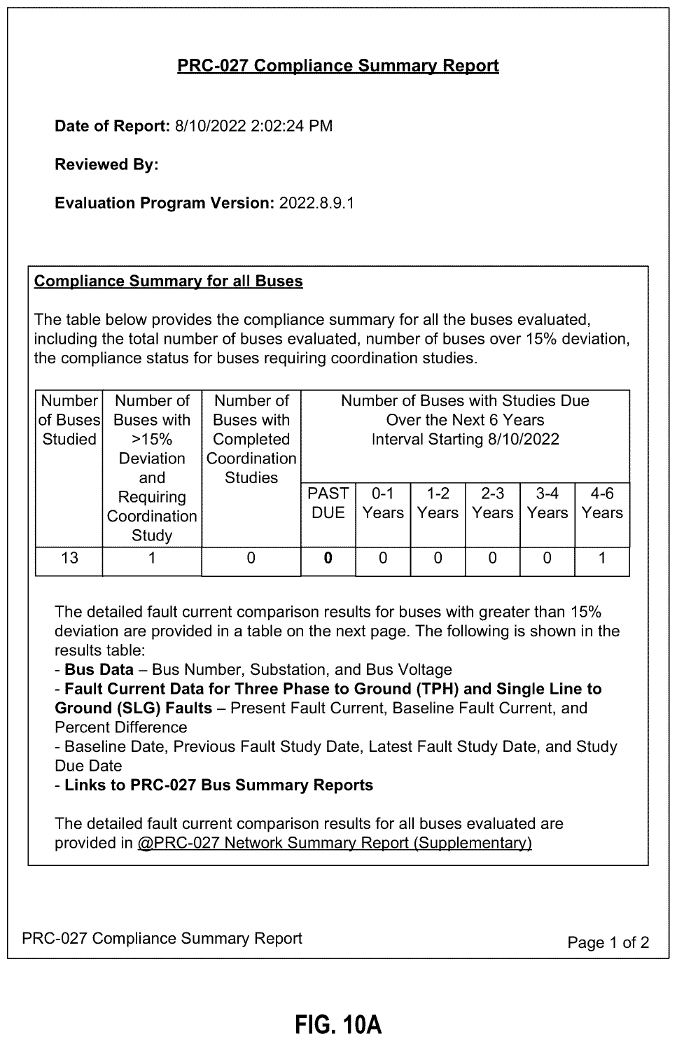

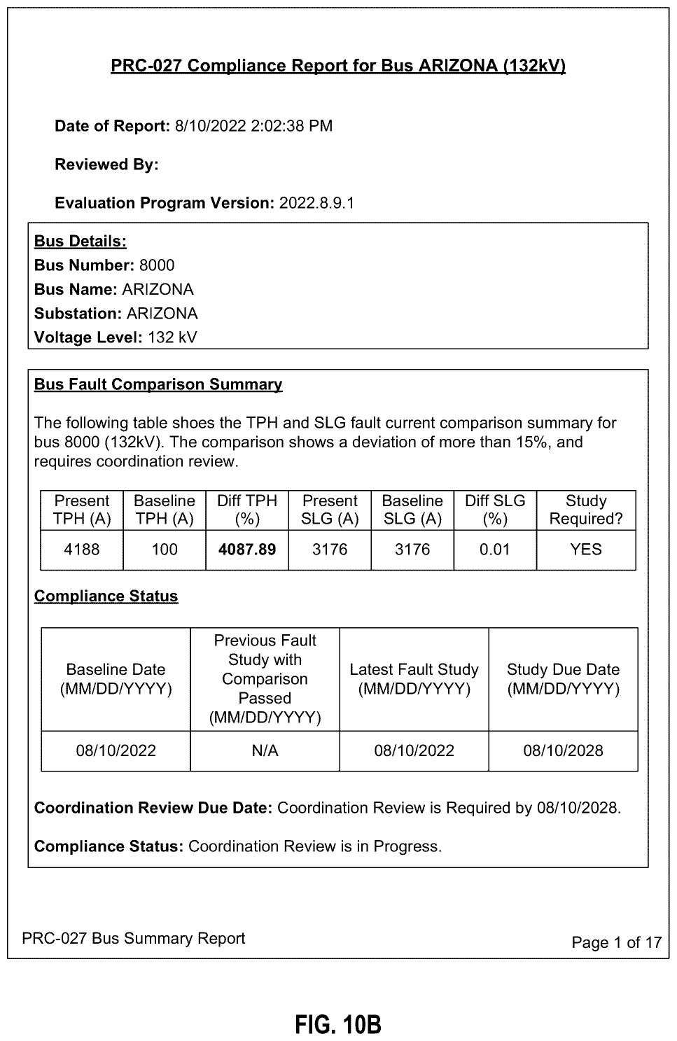

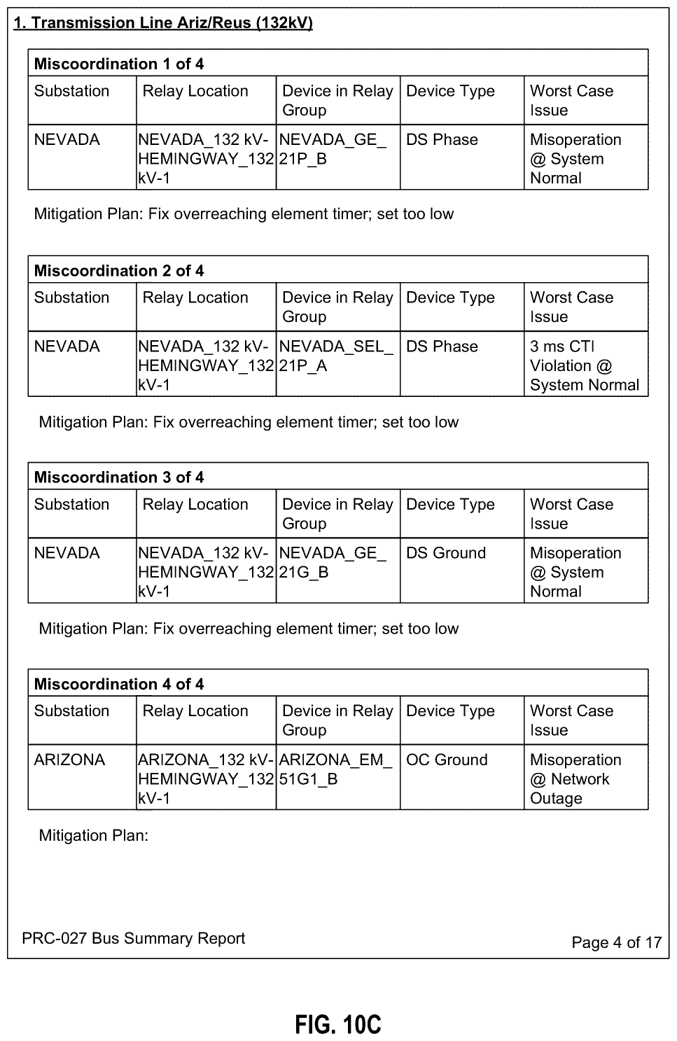

Another form of output as shown in FIGS. 10A-10C may be formal report-style documentation that can be used as proof-of-compliance for meeting regulatory requirements. Automated processes within this platform can generate these reports according to pre-defined templates, saving engineers significant time in tedious and repetitive document preparation. Although the results may be presented in a form less conducive to summarization or engineering investigation, the more formal style is suitable for dissemination among non-engineers and parties external to the engineering group.

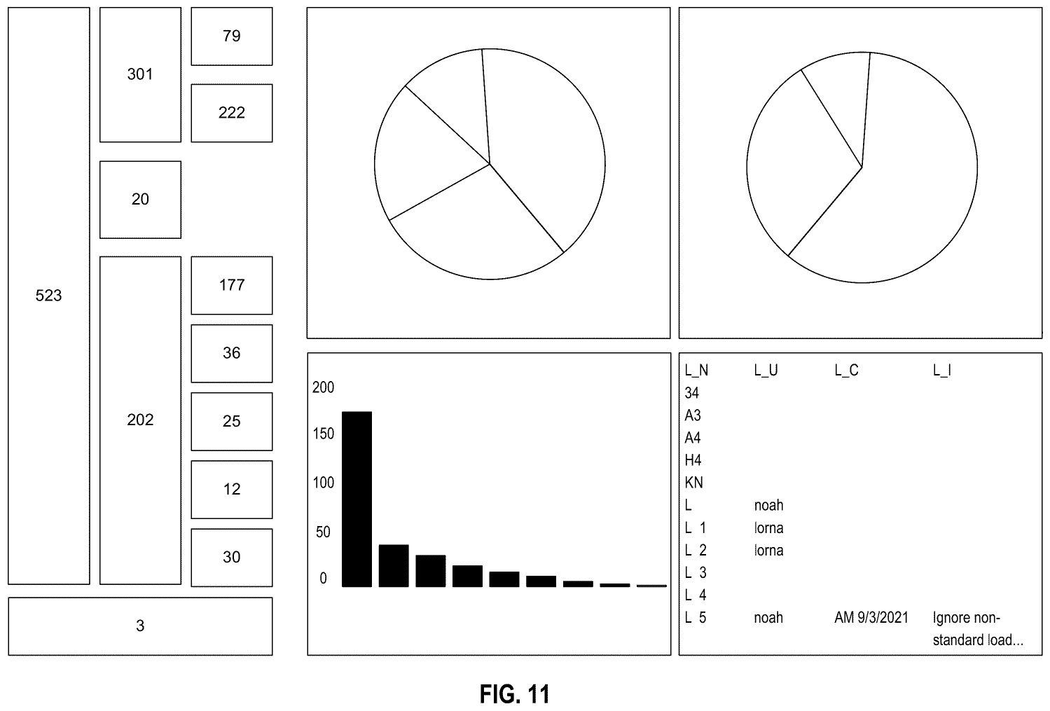

Yet another form of output as shown in FIG. 11 may be interactive data visualization dashboards that enable users to explore results data in an organized manner. These dashboards can serve in a similar manner as traditional spreadsheets, providing different levels of results details depending on user commands. However, these dashboards can go further and show dynamically updating graphics as users filter results categories and “drill down” into the results. Further, these dashboards can be linked to the results storage database, enabling published dashboards to update results automatically according to the results database. This potential for automatic updates makes these dashboards well suited to dissemination across a utility, particularly for data that must be frequently updated and provided.

Generally, then, some embodiments provide a unified platform for device configuration data that addresses accessibility, maintenance, translation, utilization, and/or reporting aspects for use with a broad spectrum of applications. Connectable to existing data storage mediums and simulation packages, this platform in some embodiments facilitates integrated processes for performance studies, compliance evaluations, and/or data analytics.

The Unified Data Platform provides a framework for the preparation and utilization of Protection, Control, and Automation device configurations within data-driven applications. This streamlines efforts into largely automated and integrated processes, improves accessibility of the configuration data, facilitates the data-driven applications themselves, and/or supports reporting and data presentation considerations.

Some embodiments more particularly mitigate process inefficiencies incurred by otherwise manual efforts in identifying, extracting, interpreting, utilizing, and/or reporting device configuration data for use in data-driven applications. The Unified Data Platform in some embodiments is based around automation-based software processes to minimize the need for manual engineer intervention.

Some embodiments herein provide an improvement in accessibility of configuration data and/or analytics results, particularly if used in conjunction with self-updating user-interactive dashboards to present the data. Other departments outside of Protection and Control need regular updates to some aspects of this data, either for operational purposes or for further analytics.

Some embodiments alternatively or additionally reduce the effort needed to develop and maintain advanced data-driven analytics routines through the elimination (or reduction) of a need for consideration of manufacturer-specific setting terminology or operations logic. The generalization of configuration data to a universal standard provides analytics applications with a consistent and accessible source for the needed device information.

Some embodiments herein transform data into a generalized form. Sensitive data such as communications ports may be omitted from the storage medium for processed configuration data. The removal of CEII data can potentially reduce the security concerns associated with enabling external application connections to the database (whereas the full device setting repository would require much more stringent cybersecurity considerations).

The Unified Data Platform provides advantages in one or more of the following aspects.

In a first aspect, automation-based solutions improve process efficiency and reduce manual effort. This enables engineers to focus less on repetitive tasks and more on those that require their expertise and experience. Further, the tight integration of these processes can enable potentially autonomous operation, streamlining efforts and ensuring constant data availability.

In a second aspect, the data transformation performed on device configuration settings simplifies the development and maintenance effort of applications that use this data. Since settings data is stated in a universal and consistent form, the need for external applications to support vendor-specific terminology and formats is reduced. Development and implementation of novel analysis methodologies can be focused on protection and system performance characteristics rather than specific manufacturer conventions.

In a third aspect, some embodiments improve accessibility of the data, enabling parties outside the traditional Protection and Control department to view and utilize the data and results. This platform makes data available at three stages: the generalized device configuration settings, the results of data-driven analytics applications, and self-updating user-interactive dashboards.

Some embodiments herein integrate into a unified data platform one or more of the following components: (i) data extraction procedures to obtain device identification, status, and configuration data from repository; (ii) device configuration interpretation processes to identify relevant settings and applicable functionality; and/or (iii) spreadsheet reporting outputs to provide engineers with multiple levels of results viewing.

Some embodiments herein introduce one or more of the following components into the unified data platform: (i) device configuration parameters generalization for vendor-specific terminology; (ii) utilization of storage elements to provide centralized accessibility for various applications (analytics or reporting); and/or (iii) utilization of user-interactive dashboards and integration with storage elements to provide users with up-to-date data and results. Some embodiments herein combine existing and/or new components to provide a holistic solution for the utilization and reporting of protection and control device configuration data.

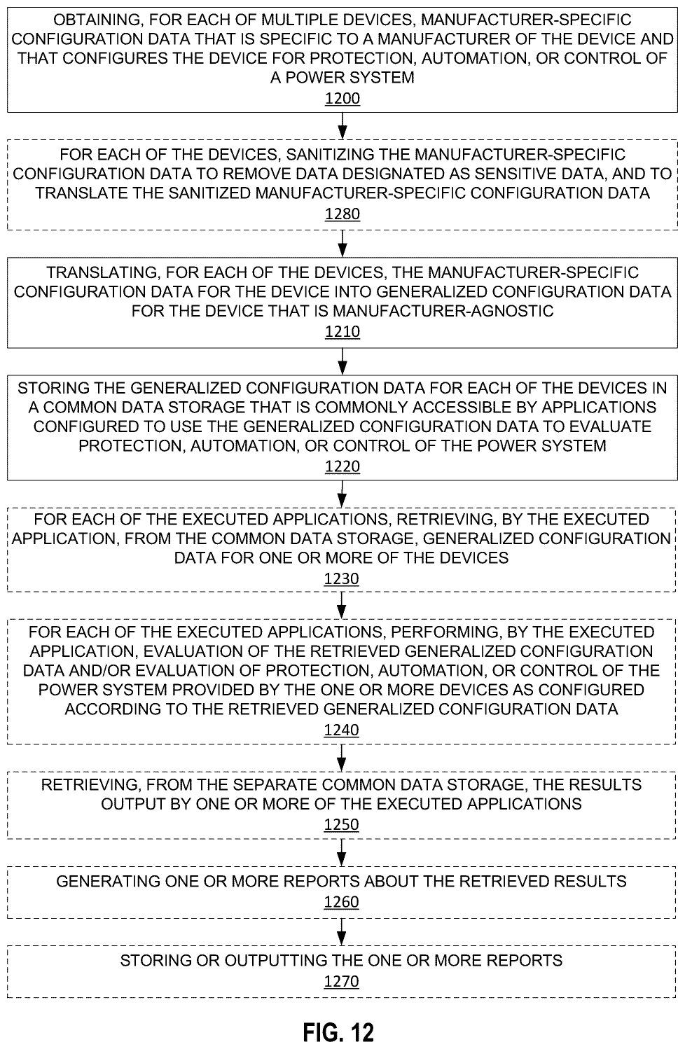

In view of the modifications and variations herein, FIG. 12 depicts a method, e.g., performed by a computing system in accordance with particular embodiments. The method includes obtaining, for each of multiple devices 12-1 . . . 12-N, manufacturer-specific configuration data 14-1 . . . 14-N that is specific to a manufacturer of the device 12-1 . . . 12-N and that configures the device 12-1 . . . 12-N for protection, automation, or control of a power system (Block 1200). The method also comprises translating, for each of the devices 12-1 . . . 12-N, the manufacturer-specific configuration data 14-1 . . . 14-N for the device 12-1 . . . 12-N into generalized configuration data 18-1 . . . 18-N for the device 12-1 . . . 12-N that is manufacturer-agnostic (Block 1210). The method also comprises storing the generalized configuration data 18-1 . . . 18-N for each of the devices 12-1 . . . 12-N in a common data storage 19 that is commonly accessible by applications 22 configured to use the generalized configuration data 18-1 . . . 18-N to evaluate protection, automation, or control of the power system (Block 1220).

In some embodiments, said translating comprises, for each of the devices 12-1 . . . 12-N, processing the manufacturer-specific configuration data 14-1 . . . 14-N for the device 12-1 . . . 12-N to identify one or more operational functions with which the manufacturer-specific configuration data 14-1 . . . 14-N configures the device 12-1 . . . 12-N. In some embodiments, said translating comprises, for each of the devices 12-1 . . . 12-N, translating manufacturer-specific parameters 20-1 . . . 20-M in the manufacturer-specific configuration data 14-1 . . . 14-N that support the one or more operational functions into generalized parameters 24-1 . . . 24-M that are manufacturer-agnostic. In some embodiments, processing the manufacturer-specific configuration data 14-1 . . . 14-N for a device 12-1 . . . 12-N to identify one or more operational functions with which the manufacturer-specific configuration data 14-1 . . . 14-N configures the device 12-1 . . . 12-N comprises parsing programmable logic in the manufacturer-specific configuration data 14-1 . . . 14-N for the device 12-1 . . . 12-N to determine one or more operational functions that underly the programmable logic. In some embodiments, processing the manufacturer-specific configuration data 14-1 . . . 14-N for a device 12-1 . . . 12-N to identify one or more operational functions with which the manufacturer-specific configuration data 14-1 . . . 14-N configures the device 12-1 . . . 12-N comprises identifying, from the one or more determined operational functions, one or more active operational functions that are active in the programmable logic, by checking which of the one or more determined operational functions are enabled according to one or more respective enable fields in the manufacturer-specific configuration data 14-1 . . . 14-N. In some embodiments, the one or more operational functions include one or more tripping elements.

In some embodiments, the generalized configuration data 18-1 . . . 18-N for a device 12-1 . . . 12-N represents the manufacturer-specific configuration data 14-1 . . . 14-N for the device 12-1 . . . 12-N with manufacturer-agnostic terminology. In other embodiments, the generalized configuration data 18-1 . . . 18-N for a device 12-1 . . . 12-N represents the manufacturer-specific configuration data 14-1 . . . 14-N for the device 12-1 . . . 12-N with alternatively or additionally one or more manufacturer-agnostic expressions. In other embodiments, the generalized configuration data 18-1 . . . 18-N for a device 12-1 . . . 12-N represents the manufacturer-specific configuration data 14-1 . . . 14-N for the device 12-1 . . . 12-N with alternatively or additionally one or more manufacturer-agnostic parameters.

In some embodiments, the common data storage 19 comprises a database of generalized configuration data 18-1 . . . 18-N organized and stored based on logical identification and/or classification of devices 12-1 . . . 12-N.

In some embodiments, the method further comprises executing the applications 22. In some embodiments executing the applications 22 comprises, for each of the executed applications 22, retrieving, by the executed application 22, from the common data storage 19, generalized configuration data 18-1 . . . 18-N for one or more of the devices 12-1 . . . 12-N (Block 1230). In some embodiments executing the applications 22 comprises, for each of the executed applications 22, performing, by the executed application 22, evaluation of the retrieved generalized configuration data 18-1 . . . 18-N and/or evaluation of protection, automation, or control of the power system provided by the one or more devices 12-1 . . . 12-N as configured according to the retrieved generalized configuration data 18-1 . . . 18-N (Block 1240). In some embodiments, executing the applications 22 further comprises, for each of the executed applications 22, outputting results 26 of the evaluation by the executed application 22 to a separate common data storage 28 that is logically and/or physically separate from the common data storage 19 storing the generalized configuration data 18-1 . . . 18-N and that commonly stores results 26 of the respective evaluations by the executed applications 22. In some embodiments, the method further comprises retrieving, from the separate common data storage 28, the results 26 output by one or more of the executed applications 22 (Block 1250). In some embodiments, the method further comprises generating one or more reports about the retrieved results 26 (Block 1260). In some embodiments, the method further comprises storing or outputting the one or more reports (Block 1270).

In some embodiments, the method further comprises, for each of the devices 12-1 . . . 12-N, sanitizing the manufacturer-specific configuration data 14-1 . . . 14-N to remove data designated as sensitive data, and to translate the sanitized manufacturer-specific configuration data 14-1 . . . 14-N (Block 1280).

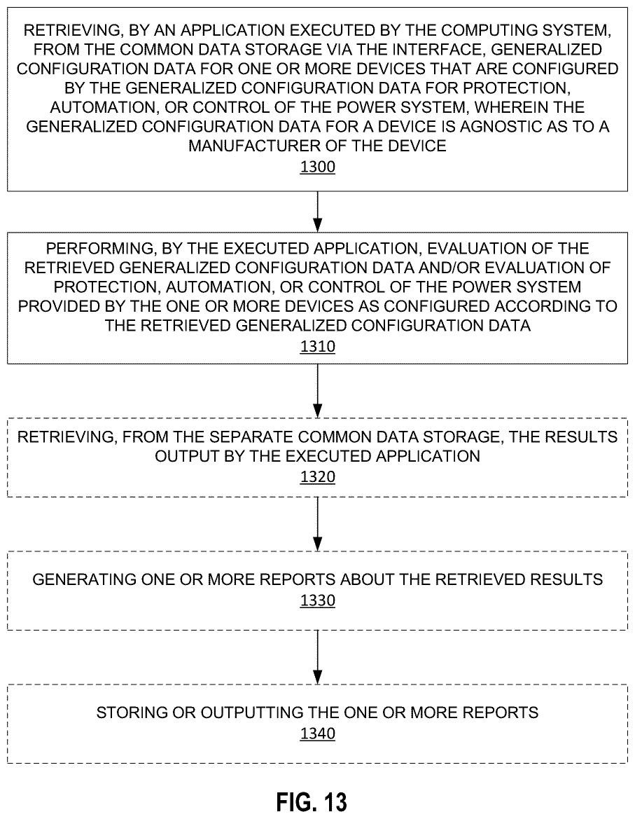

FIG. 13 depicts a method performed by a computing system comprising an interface to a common data storage 19 that is commonly accessible by applications 22 configured to evaluate protection, automation, or control of a power system, and processing circuitry in accordance with particular embodiments. The method includes retrieving, by an application 22 executed by the computing system, from the common data storage 19 via the interface, generalized configuration data 18-1 . . . 18-N for one or more devices 12-1 . . . 12-N that are configured by the generalized configuration data 18-1 . . . 18-N for protection, automation, or control of the power system, wherein the generalized configuration data 18-1 . . . 18-N for a device 12-1 . . . 12-N is agnostic as to a manufacturer of the device 12-1 . . . 12-N (Block 1300). The method also comprises performing, by the executed application 22, evaluation of the retrieved generalized configuration data 18-1 . . . 18-N and/or evaluation of protection, automation, or control of the power system provided by the one or more devices 12-1 . . . 12-N as configured according to the retrieved generalized configuration data 18-1 . . . 18-N (Block 1310).

In some embodiments, the generalized configuration data 18-1 . . . 18-N for a device 12-1 . . . 12-N represents manufacturer-specific configuration data 14-1 . . . 14-N for the device 12-1 . . . 12-N with manufacturer-agnostic terminology. In other embodiments, the generalized configuration data 18-1 . . . 18-N for a device 12-1 . . . 12-N represents manufacturer-specific configuration data 14-1 . . . 14-N for the device 12-1 . . . 12-N with alternatively or additionally one or more manufacturer-agnostic expressions. In other embodiments, the generalized configuration data 18-1 . . . 18-N for a device 12-1 . . . 12-N represents manufacturer-specific configuration data 14-1 . . . 14-N for the device 12-1 . . . 12-N with alternatively or additionally one or more manufacturer-agnostic parameters.

In some embodiments, the common data storage 19 comprises a database of generalized configuration data 18-1 . . . 18-N organized and stored based on logical identification and/or classification of devices 12-1 . . . 12-N.

In some embodiments, the processing circuitry is further configured to output results 26 of the evaluation by the executed application 22 to a separate common data storage 28 that is logically and/or physically separate from the common data storage 19 storing the generalized configuration data 18-1 . . . 18-N and that commonly stores results 26 of the evaluations by multiple applications 22. In some embodiments, the method further comprises retrieving, from the separate common data storage 28, the results 26 output by the executed application 22 (Block 1320). In some embodiments, the method further comprises generating one or more reports about the retrieved results 26 (Block 1330). In some embodiments, the method further comprises storing or outputting the one or more reports (Block 1340).

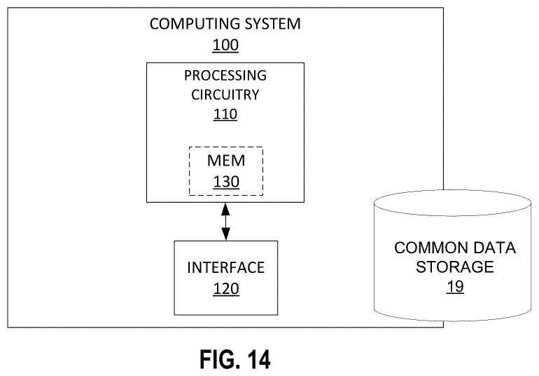

Note that any of the steps in the method of FIG. 12 and/or FIG. 13 may be implemented by a computing system 100 shown in FIG. 14. For example, the computing system 100 may implement any one or more of the data translator 16, the common data storage 19, the application(s) 22, the results storage 28, and the report generator 30 shown in FIG. 1. As shown in FIG. 14, the computing system 100 includes processing circuitry 110. The processing circuitry 110 is configured to perform processing described above, e.g., in FIG. 12 and/or FIG. 13, such as by executing instructions stored in memory 130. The processing circuitry 110 in this regard may implement certain functional means, units, or modules.

The computing system 100 may also include an interface 120 for accessing one or more data storages described herein, e.g., common data storage 19. One or more of these data storages may be internal or external to the computing system 100. One or more data storages in this regard may be local data storages or cloud-based data storages.

The computing system 100 described above may perform the methods herein and any other processing by implementing any functional means, modules, units, or circuitry. In one embodiment, for example, the computing system 100 comprises respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more communications protocols as well as instructions for carrying out one or more of the techniques described herein, in several embodiments. In embodiments that employ memory, the memory stores program code that, when executed by the one or more processors, carries out the techniques described herein.

Note, too, that the computing system 100 may take any number of forms in different embodiments. For example, the computing system 100 may comprise dedicated hardware or equipment for performing any of the embodiments herein. The computing system 100 in these and other embodiments may comprise one or more computing devices. In embodiments where the computing system 100 comprises multiple computing devices, the computing system 100 may for example comprise different computing devices for supporting at least some different components or processes, e.g., one computing device supporting data translator 16, another computing device supporting common data storage 19, etc. Alternatively, the computing system 100 may provide any of the embodiments herein as an online or cloud-based platform that is offered as a software-as-a-service product or a platform-as-a-service product. In still other embodiments, the computing system 100 may perform one or more embodiments herein by executing a downloadable software package or plugin with corresponding instructions.

Those skilled in the art will also appreciate that embodiments herein further include corresponding computer programs.

A computer program comprises instructions which, when executed on at least one processor of computing system 100, cause the computing system 100 to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of computing system 100, cause the computing system 100 to perform as described above.

Embodiments further include a computer program product comprising program code portions for performing the steps of any of the embodiments herein when the computer program product is executed by a computing system. This computer program product may be stored on a computer readable recording medium.

1. A method comprising:
obtaining, for each of multiple devices, manufacturer-specific configuration data that is specific to a manufacturer of the device and that configures the device for protection, automation, or control of a power system;
translating, for each of the devices, the manufacturer-specific configuration data for the device into generalized configuration data for the device that is manufacturer-agnostic; and
storing the generalized configuration data for each of the devices in a common data storage that is commonly accessible by applications configured to use the generalized configuration data to evaluate protection, automation, or control of the power system.

2. The method of claim 1, wherein said translating comprises, for each of the devices, translating manufacturer-specific parameters in the manufacturer-specific configuration data into generalized parameters that are manufacturer-agnostic.

3. The method of claim 1, wherein said translating comprises, for each of the devices:
processing the manufacturer-specific configuration data for the device to identify one or more operational functions with which the manufacturer-specific configuration data configures the device; and
translating manufacturer-specific parameters in the manufacturer-specific configuration data that support the one or more operational functions into generalized parameters that are manufacturer-agnostic.

4. The method of claim 3, wherein processing the manufacturer-specific configuration data for a device to identify one or more operational functions with which the manufacturer-specific configuration data configures the device comprises:
parsing programmable logic in the manufacturer-specific configuration data for the device to determine one or more operational functions that underly the programmable logic; and
identifying, from the one or more determined operational functions, one or more active operational functions that are active in the programmable logic, by checking which of the one or more determined operational functions are enabled according to one or more respective enable fields in the manufacturer-specific configuration data.

5. The method of claim 1, wherein the generalized configuration data for a device represents the manufacturer-specific configuration data for the device with:
manufacturer-agnostic terminology;
one or more manufacturer-agnostic expressions; and/or
one or more manufacturer-agnostic parameters.

6. The method of claim 1, wherein the common data storage comprises a database of generalized configuration data organized and stored based on logical identification and/or classification of devices.

7. The method of claim 1, wherein the method further comprises executing the applications by, for each of the executed applications:
retrieving, by the executed application, from the common data storage, generalized configuration data for one or more of the devices; and
performing, by the executed application, evaluation of the retrieved generalized configuration data and/or evaluation of protection, automation, or control of the power system provided by the one or more devices as configured according to the retrieved generalized configuration data.

8. The method of claim 7, wherein executing the applications further comprises, for each of the executed applications, outputting results of the evaluation by the executed application to a separate common data storage that is logically and/or physically separate from the common data storage storing the generalized configuration data and that commonly stores results of the respective evaluations by the executed applications.

9. The method of claim 8, further comprising:
retrieving, from the separate common data storage, the results output by one or more of the executed applications;
generating one or more reports about the retrieved results; and
storing or outputting the one or more reports.

10. The method of claim 1, further comprising, for each of the devices, sanitizing the manufacturer-specific configuration data to remove data designated as sensitive data, and wherein said translating comprises translating the sanitized manufacturer-specific configuration data.

11. A computing system comprising processing circuitry configured to:
obtain, for each of multiple devices, manufacturer-specific configuration data that is specific to a manufacturer of the device and that configures the device for protection, automation, or control of a power system;
translate, for each of the devices, the manufacturer-specific configuration data for the device into generalized configuration data for the device that is manufacturer-agnostic; and
store the generalized configuration data for each of the devices in a common data storage that is commonly accessible by applications configured to use the generalized configuration data to evaluate protection, automation, or control of the power system.

12. The computing system of claim 11, wherein the processing circuitry is configured to, for each of the devices, translate manufacturer-specific parameters in the manufacturer-specific configuration data into generalized parameters that are manufacturer-agnostic.

13. The computing system of claim 11, wherein the processing circuitry is configured to, for each of the devices:
process the manufacturer-specific configuration data for the device to identify one or more operational functions with which the manufacturer-specific configuration data configures the device; and
translate manufacturer-specific parameters in the manufacturer-specific configuration data that support the one or more operational functions into generalized parameters that are manufacturer-agnostic.

14. The computing system of claim 13, wherein the processing circuitry is configured to process the manufacturer-specific configuration data for a device to identify one or more operational functions with which the manufacturer-specific configuration data configures the device, by:
parsing programmable logic in the manufacturer-specific configuration data for the device to determine one or more operational functions that underly the programmable logic; and
identifying, from the one or more determined operational functions, one or more active operational functions that are active in the programmable logic, by checking which of the one or more determined operational functions are enabled according to one or more respective enable fields in the manufacturer-specific configuration data.

15. The computing system of claim 11, wherein the generalized configuration data for a device represents the manufacturer-specific configuration data for the device with:
manufacturer-agnostic terminology;
one or more manufacturer-agnostic expressions; and/or
one or more manufacturer-agnostic parameters.

16. The computing system of claim 11, wherein the common data storage comprises a database of generalized configuration data organized and stored based on logical identification and/or classification of devices.

17. The computing system of claim 11, wherein the processing circuitry is configured to execute the applications by, for each of the executed applications:
retrieving, by the executed application, from the common data storage, generalized configuration data for one or more of the devices; and
performing, by the executed application, evaluation of the retrieved generalized configuration data and/or evaluation of protection, automation, or control of the power system provided by the one or more devices as configured according to the retrieved generalized configuration data.

18. The computing system of claim 17, wherein the processing circuitry is configured to execute the applications further by, for each of the executed applications, outputting results of the evaluation by the executed application to a separate common data storage that is logically and/or physically separate from the common data storage storing the generalized configuration data and that commonly stores results of the respective evaluations by the executed applications.

19. The computing system of claim 18, wherein the processing circuitry is further configured to:
retrieve, from the separate common data storage, the results output by one or more of the executed applications;
generate one or more reports about the retrieved results; and
store or output the one or more reports.

20. The computing system of claim 11, wherein the processing circuitry is further configured to, for each of the devices, sanitize the manufacturer-specific configuration data to remove data designated as sensitive data, and wherein the processing circuitry is configured to translate the sanitized manufacturer-specific configuration data.

21. A non-transitory computer-readable storage medium on which is stored instructions that, when executed by one or more processors of a computing system, cause the computing system to:
obtain, for each of multiple devices, manufacturer-specific configuration data that is specific to a manufacturer of the device and that configures the device for protection, automation, or control of a power system;
translate, for each of the devices, the manufacturer-specific configuration data for the device into generalized configuration data for the device that is manufacturer-agnostic; and
store the generalized configuration data for each of the devices in a common data storage that is commonly accessible by applications configured to use the generalized configuration data to evaluate protection, automation, or control of the power system.
